(19) United States
(12) Patent Application Publication
(10) Pub. No.: US 2026/0030781 A1
(43) Pub. Date: Jan. 29, 2026

(54) SIGNAL PROCESSING DEVICE AND SIGNAL PROCESSING METHOD

(71) Applicant: SONY SEMICONDUCTOR SOLUTIONS CORPORATION, KANAGAWA (JP)

(72) Inventor: DAIKI TANAKA, KANAGAWA (JP)

(21) Appl. No.: 18/998,504

(22) PCT Filed: Jul. 24, 2023
(86) PCT No.: PCT/JP2023/026959

§ 371 Date: Jan. 26, 2025

(30) Foreign Application Priority Data
Aug. 5, 2022 (JP) 2022-125562

(51) Int. Cl. G06T 7/73; G06K 7/14; G06T 7/246

(52) U.S. Cl. CPC G06T 7/74; G06T 7/248; G06K 7/1413; G06T 2207/10016

(57) ABSTRACT

A signal processing device includes: a position detection unit that, on the basis of a captured image by an imaging unit that captures a moving target object, detects a position of the target object in the captured image as an object position; a position estimation unit that estimates a position of the target object in the captured image of next and subsequent frames as a predicted position on the basis of the detected object position and a movement speed of the target object; and a frame setting unit that sets a cut-out frame in the captured image of the next and subsequent frames according to the predicted position.

### TECHNICAL FIELD

The present technology relates to a technical field of a signal processing device and a signal processing method that follow a moving object as a detection target object, generate and output a cut-out image so as to include the moving object.

### BACKGROUND ART

There is a region of interest (ROI) function of cutting out a partial region from a captured image captured over the entire angle of view. In some ROI functions, only partial image data of a region including a target object is output by setting an ROI so as to track a detected subject in a case where the subject moves (for example, Patent Document 1 below).

### CITATION LIST

### Patent Document

PATENT DOCUMENT 1 Japanese Patent Application Laid-Open No. 2021-166317.

### SUMMARY OF THE INVENTION

### Problems to be Solved by the Invention

The ROI function of tracking a subject has a problem that a processing load is large because a subject to be tracked in each frame image is detected by image processing.

The present technology has been made in view of such a problem, and an object thereof is to reduce a processing load on an ROI function of tracking a subject.

### Solutions to Problems

A signal processing device according to the present technology includes: a position detection unit that, on the basis of a captured image by an imaging unit that captures a moving target object, detects a position of the target object in the captured image as an object position; a position estimation unit that estimates a position of the target object in the captured image of next and subsequent frames as a predicted position on the basis of the detected object position and a movement speed of the target object; and a frame setting unit that sets a cut-out frame in the captured image of the next and subsequent frames according to the predicted position.

As a result, the cut-out frame can be set so as to include the position of the target object predicted on the basis of the object position and the movement speed.

### BRIEF DESCRIPTION OF DRAWINGS

FIG. 1 is a block diagram of a camera apparatus.

FIG. 2 is a diagram for explaining a cut-out frame and a detection frame set in a partial region of a captured image.

FIG. 3 is a diagram illustrating an example in which a detection frame wider than a cut-out frame is set.

FIG. 4 is a diagram for explaining an outline of monitoring of a barcode.

FIG. 5 is a diagram for explaining a state in which a cut-out frame is set so as to follow a barcode.

FIG. 6 is a block diagram illustrating a functional configuration of an image sensor in a first embodiment.

FIG. 7 is an example of output data conforming to the MIPI standard.

FIG. 8 is a flowchart of an example of processing executed by a control unit of the image sensor.

FIG. 9 is a block diagram illustrating a functional configuration of an image sensor in a second embodiment.

FIG. 10 is a block diagram illustrating a functional configuration of an image sensor in a third embodiment.

### MODE FOR CARRYING OUT THE INVENTION

Hereinafter, embodiments according to the present technology will be described in the following order with reference to the accompanying drawings.
<1. Configuration of signal processing device>
<2. Overview of monitoring by signal processing device>
<3. Functional configuration of signal processing device>
<4. Flow of processing>
<5. Second embodiment>
<6. Third embodiment>
<7. Summary>
<8. Present technology>

### 1. Configuration of Signal Processing Device

A signal processing device of a first embodiment according to the present embodiment is a device that performs various types of processing on a captured image captured by an imaging unit. Such a signal processing device can be considered in various ways, and in the following description, an image sensor IS will be described.

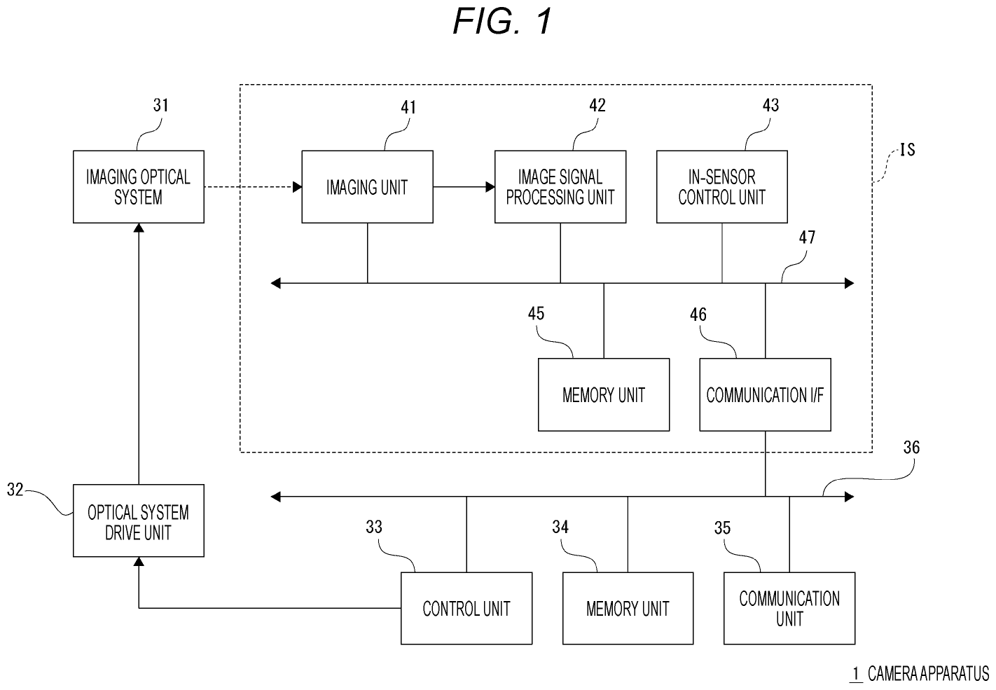

The image sensor IS is provided in a camera apparatus 1. An internal configuration example of the camera apparatus 1 will be described with reference to FIG. 1.

The camera apparatus 1 includes an image sensor IS, an imaging optical system 31, an optical system drive unit 32, a control unit 33, a memory unit 34, and a communication unit 35.

The image sensor IS, the control unit 33, the memory unit 34, and the communication unit 35 are connected to each other over a bus 36 so as to communicate data with each other.

The imaging optical system 31 includes lenses such as a cover lens, a zoom lens, and a focus lens, and a diaphragm (iris) mechanism. Light (incident light) from a subject is guided by the imaging optical system 31, and the light is condensed on a light receiving surface of the image sensor IS.

The optical system drive unit 32 comprehensively represents drive units of the zoom lens, the focus lens, and the diaphragm mechanism included in the imaging optical system 31. Specifically, the optical system drive unit 32 includes an actuator for driving each of the zoom lens, the focus lens, and the diaphragm mechanism, and a drive circuit of the actuator.

The control unit 33 includes, for example, a microcomputer including a central processing unit (CPU), a read only memory (ROM), and a random access memory (RAM), and performs overall control of the camera apparatus 1 by the CPU executing various types of processing in accordance with a program stored in the ROM or a program loaded in the RAM.

Furthermore, the control unit 33 instructs the optical system drive unit 32 to drive the zoom lens, the focus lens, the diaphragm mechanism, and the like. The optical system drive unit 32 moves the focus lens and the zoom lens, opens or closes a diaphragm blade of the diaphragm mechanism, or the like in response to such a drive instruction.

Furthermore, the control unit 33 controls the writing and reading of various types of data to and from the memory unit 34.

The memory unit 34 is a non-volatile storage device such as a hard disk drive (HDD) or a flash memory device, and is used as a storage destination (recording destination) of image data output from the image sensor IS.

Moreover, the control unit 33 communicates various data with an external device via the communication unit 35.

The camera apparatus 1 in the present example is used, for example, for the purpose of monitoring (or checking) an object to be monitored that is placed on an object transport mechanism such as a belt conveyor and moves. That is, the camera apparatus 1 performs various checks on a monitoring object OB by performing predetermined image processing on the basis of captured image data obtained by imaging the monitoring object OB.

The communication unit 35 is configured to be able to perform data communication with a belt conveyor control device or the like, and can output monitoring results (check results) thereof to the outside. As a result, the monitoring object OB in which the failure has occurred can be removed from the belt conveyor, or an alert can be generated.

The image sensor IS is configured as, for example, a CCD type, a CMOS type, or the like image sensor.

The image sensor IS includes an imaging unit 41, an image signal processing unit 42, an in-sensor control unit 43, a memory unit 45, and a communication I/F 46, which are capable of performing data communication with each other via a bus 47.

The imaging unit 41 includes a pixel array unit in which pixels each including a photoelectric conversion element such as a photodiode are two-dimensionally arranged, and a readout circuit that reads an electric signal obtained by photoelectric conversion from each pixel included in the pixel array unit, and can output the electric signal as a captured image signal.

The readout circuit performs, for example, correlated double sampling (CDS) processing, automatic gain control (AGC) processing, and the like on the electric signal obtained by the photoelectric conversion, and further performs analog/digital (A/D) conversion processing on the electric signal.

The image signal processing unit 42 performs preprocessing, synchronization processing, YC generation processing, resolution conversion processing, codec processing, and the like on a captured image signal as digital data obtained as a result of the A/D conversion processing.

In the preprocessing, clamp processing of clamping the black levels of R, G, and B to a predetermined level, correction processing between the color channels of R, G, and B, and the like are performed on the captured image signal. In the synchronization processing, color separation processing is performed such that image data for each pixel has all the R, G, and B color components. For example, in a case of an imaging element using a color filter of Bayer array, demosaicing processing is performed as the color separation processing. In the YC generation processing, a luminance (Y) signal and a color (C) signal are generated (separated) from the image data of R, G, and B. In the resolution conversion processing, resolution conversion processing is performed on the image data subjected to various types of signal processing.

In the codec processing, for example, encoding processing for recording or communication and file generation are performed on the image data subjected to the various types of processing described above. In the codec processing, it is possible to generate a file in a format such as moving picture experts group (MPEG)-2 or H.264 as a moving image file format. It is also conceivable to generate a file in a format such as joint photographic experts group (JPEG), tagged image file format (TIFF), or graphics interchange format (GIF) as a still image file. Note that, in a case where the image sensor IS is a distance measurement sensor, the image signal processing unit 42 calculates distance information regarding the subject on the basis of, for example, two signals output from the image sensor IS as an indirect time of flight (iToF), and outputs a distance image.

The in-sensor control unit 43 gives an instruction to the imaging unit 41 to perform execution control of an imaging operation. Similarly, execution of processing is also controlled for the image signal processing unit 42.

The image signal processing unit 42 and the in-sensor control unit 43 according to the present embodiment perform various types of processing in order to monitor (or check) the monitoring object OB that moves while being placed on the object transport mechanism such as a belt conveyor.

Specifically, as will be described later, the image signal processing unit 42 and the in-sensor control unit 43 perform binarization processing, mask processing, moment processing, center of gravity calculation processing, frame position calculation processing, movement amount calculation processing, movement speed acquisition processing, position estimation processing, image cut-out processing, output data shaping processing, and the like.

Each processing may be performed by either the image signal processing unit 42 or the in-sensor control unit 43. That is, each processing may be realized by hardware such as a logic circuit, or may be realized by software by a program or the like.

The memory unit 45 can be used as a so-called frame memory that stores captured image data (RAW image data) obtained by the image signal processing unit 42 and image data after the synchronization processing. Furthermore, the memory unit 45 may be used for storing temporary data generated when the image signal processing unit 42 or the in-sensor control unit 43 executes each processing described above.

The communication I/F 46 is an interface that communicates with the control unit 33, the memory unit 34, and the like located outside the image sensor IS. The communication I/F 46 performs communication for acquiring a program or the like executed by the image signal processing unit 42 from the outside, and stores the program or the like in the memory unit 45 included in the image sensor IS.

### 2. Overview of Monitoring by Signal Processing Device

As described above, the image sensor IS as a signal processing device captures an image of the monitoring object OB transported by the object transport mechanism such as a belt conveyor, and outputs a partial image of a region including a target object that is a part of the monitoring object OB as an ROI image.

For example, the monitoring object OB is a product or the like put in a packaging material such as cardboard, and a barcode BC such as a one-dimensional code or a two-dimensional code is attached to a surface of the packaging material. The image sensor IS monitors these barcodes BC as monitoring targets.

In the following description, the barcode BC will be described as an example of a target object that is a part of the monitoring object OB, but the target object may be something other than that. For example, the target object may be a part (for example, a handle or the like) of a product, and the image sensor IS may determine whether or not the part is normally attached to the product.

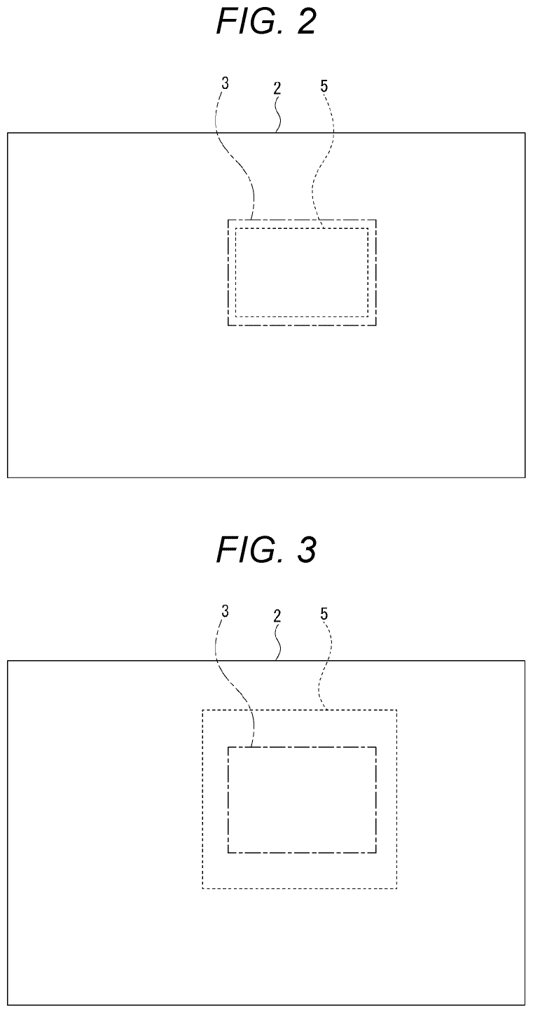

In order to detect the barcode BC on the monitoring object OB, the image sensor IS outputs a partial region on a captured image 2 corresponding to an effective region of a sensor surface as the ROI region. For this purpose, the image sensor IS sets a frame for cutting out the ROI region as a cut-out frame 3 (see FIG. 2).

The partial image cut out by the cut-out frame 3 is an ROI image 4.

In FIG. 2, the cut-out frame 3 is indicated by a one-dot chain line.

A partial region in the cut-out frame 3 is set as a target region for performing image processing for object recognition. The image sensor IS sets a detection frame 5 as a frame for specifying the target region. The detection frame 5 is indicated by a broken line in FIG. 2.

The detection frame 5 is set such that the barcode BC is located within the frame when the monitoring object OB is transported to a predetermined position in the object transport mechanism. In a case where there is a possibility that the position of the barcode BC is greatly shifted, the detection frame 5 is also set to be large. At this time, the detection frame 5 may be set to be larger than the cut-out frame 3 (see FIG. 3).

The cut-out frame 3 and the detection frame 5 are set to move in the captured image 2 so as to follow the movement of the barcode BC in a case where the barcode BC is detected. In other words, the image sensor IS sets the cut-out frame 3 and the detection frame 5 such that the moving barcode BC falls within the frame.

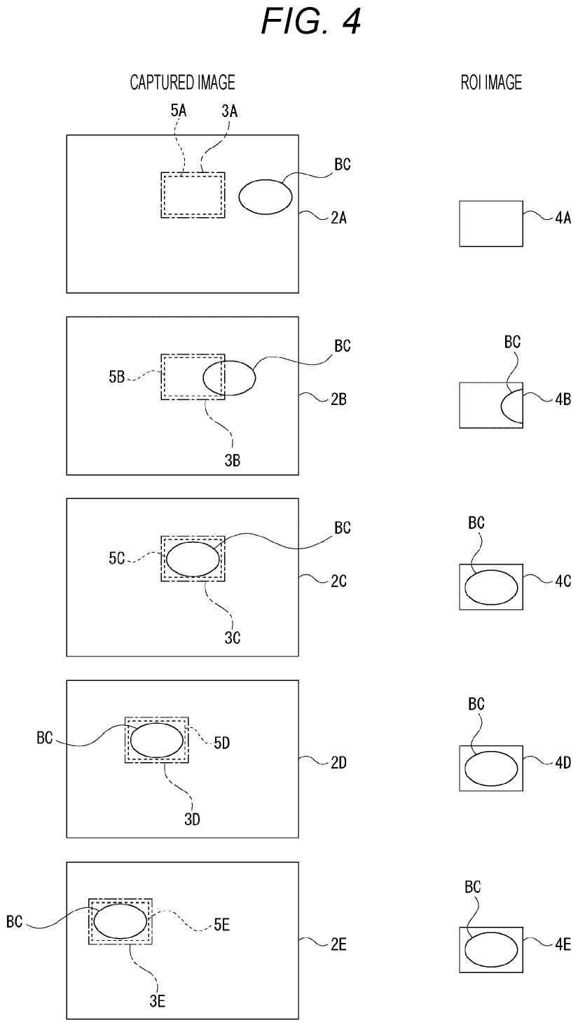

FIG. 4 illustrates an outline of a positional relationship among the cut-out frame 3, the detection frame 5, and the barcode BC. FIG. 4 illustrates five captured images 2, and the cut-out frame 3 and the detection frame 5 set on each of the captured images 2. The five captured images 2 are sequentially arranged in time series from the top, and are captured images 2A, 2B, 2C, 2D, and 2E.

Furthermore, FIG. 4 illustrates ROI images 4A, 4B, 4C, 4D, and 4E corresponding to the captured images 2A, 2B, 2C, 2D, and 2E.

On the captured image 2A, a cut-out frame 3A and a detection frame 5A are set. Furthermore, the barcode BC is not detected in the detection frame 5A of the captured image 2A.

On the captured image 2B, a cut-out frame 3B and a detection frame 5B are set. A part of the barcode BC is detected in the detection frame 5B of the captured image 2B. In this manner, in a case where it is determined that a part of the barcode BC has been detected in the detection frame 5B, the image sensor IS may capture the barcode BC in the detection frame 5 as early as possible by setting the cut-out frame 3 and the detection frame 5 to be shifted in a right direction in the drawing in the captured image 2 as the next frame image (not illustrated).

On the captured image 2C, a cut-out frame 3C and a detection frame 5C are set. Furthermore, the entire barcode BC is included in the detection frame 5C of the captured image 2C, and the barcode BC is detected.

On the captured image 2D, a cut-out frame 3D and a detection frame 5D are set. Furthermore, the cut-out frame 3D and the detection frame 5D are set to be shifted in a left direction in the drawing with the movement of the barcode BC. The entire barcode BC is included in the detection frame 5D of the captured image 2D, and the barcode BC is detected.

On the captured image 2E, a cut-out frame 3E and a detection frame 5E are set. Furthermore, the cut-out frame 3E and the detection frame 5E are set to be further shifted in the left direction in the drawing along with the movement of the barcode BC. The entire barcode BC is included in the detection frame 5E of the captured image 2E, and the barcode BC is detected.

Note that the image sensor IS acquires a movement speed of the barcode BC, and after acquiring the movement speed, performs processing of predicting a position of the barcode BC on the basis of the movement speed. At this time, image processing for detecting the barcode BC in the detection frame 5 is not performed. Therefore, the image sensor IS may not set the detection frame 5 after calculating the movement speed.

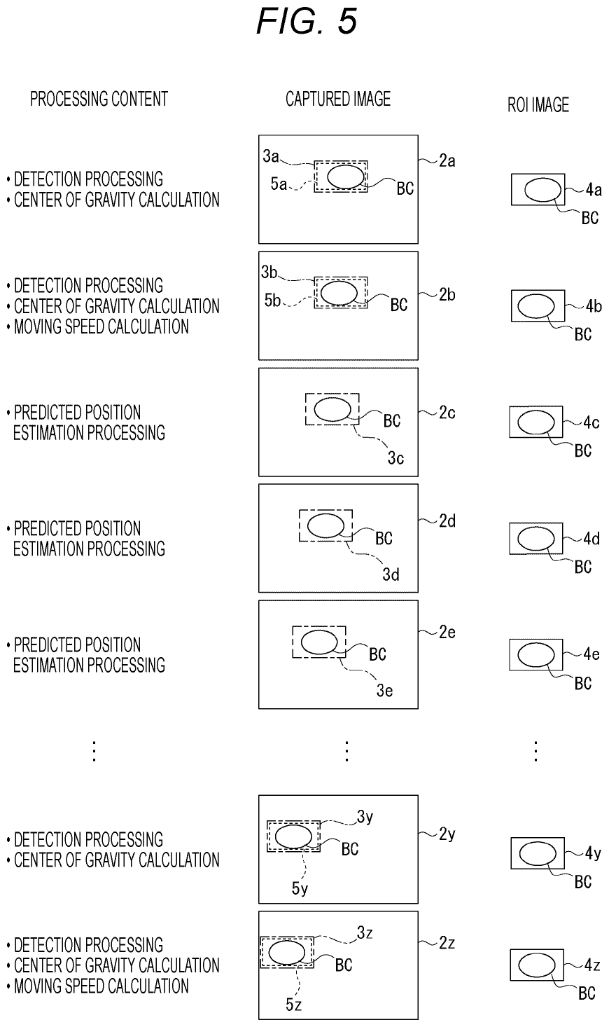

Specifically, a flow of processing executed by the image sensor IS will be described with reference to FIG. 5.

FIG. 5 illustrates a relationship among the captured image 2 captured by the image sensor IS, the ROI image 4 output according to the cut-out frame 3 set on the captured image 2, and processing executed by the image signal processing unit 42 or the in-sensor control unit 43 at that time.

The captured images 2 are captured images 2a, 2b, 2c, 2d, and 2e in chronological order and frame by frame, and are captured images 2y and 2z after captured images 2 (not illustrated). The captured images 2y and 2z are images of the last two frames when the tracking of the barcode BC is stopped.

Note that, in FIG. 5, the captured image 2 captured before the captured image 2a, that is, the captured image 2 until the entire barcode BC is captured in the detection frame 5 is omitted. That is, the captured image 2a is the first captured image 2 in which the entire barcode BC is contained in the detection frame 5.

The image signal processing unit 42 and the in-sensor control unit 43 (hereinafter simply referred to as “control unit”) of the image sensor IS perform image processing in a detection frame 5a on the captured image 2a to perform detection processing of detecting the barcode BC. As a result, in response to the detection of the barcode BC in the detection frame 5a, the control unit of the image sensor IS calculates a center of gravity position of the barcode BC. As a result, the position of the barcode BC is determined. This will be specifically described later.

On the captured image 2b captured next to the captured image 2a, a cut-out frame 3b and a detection frame 5b are set in the image. The positions of the cut-out frame 3b and the detection frame 5b in the image are the same as the positions of a cut-out frame 3a and the detection frame 5a in the captured image 2a. That is, the cut-out frames 3a and 3b are set at predetermined positions in the image, and the detection frames 5a and 5b are set at predetermined positions in the image different from the cut-out frames 3a and 3b.

The control unit of the image sensor IS performs detection processing of detecting the barcode BC by performing image processing in the detection frame 5b on the captured image 2b.

Furthermore, the control unit of the image sensor IS calculates a center of gravity position of the barcode BC and specifies the position of the barcode BC.

Furthermore, the control unit of the image sensor IS calculates a movement speed of the barcode BC according to a difference between the center of gravity position of the barcode BC for the captured image 2a and the center of gravity position of the barcode BC for the captured image 2b, and a length of a frame period.

For the captured image 2c captured subsequently to the captured image 2b, the control unit of the image sensor IS performs processing of estimating a predicted position of the barcode BC on the captured image 2c, and sets a cut-out frame 3c so as to include the predicted position.

Similarly, for the captured images 2d and 2e, the control unit of the image sensor IS estimates a predicted position of the barcode BC on the captured images 2d and 2e and sets cut-out frames 3d and 3e.

The control unit of the image sensor IS does not perform image processing for detecting the barcode BC on the captured images 2c, 2d, and 2e. As a result, the processing load of the control unit of the image sensor IS can be reduced, and a reduction in power consumption can be achieved.

Note that a period during which the cut-out frame 3 is set on the basis of the predicted position of the barcode BC is referred to as a “tracking period”.

When the tracking period of the barcode BC ends, that is, when the estimation of the predicted position of the barcode BC ends, the control unit of the image sensor IS again sets detection frames 5y and 5z as illustrated in the captured images 2y and 2z of FIG. 5.

That is, the control unit of the image sensor IS specifies the positions of the barcode BC in the detection frames 5y and 5z. At this time, the control unit of the image sensor IS performs detection processing of the barcode BC and center of gravity position calculation processing. Furthermore, the control unit of the image sensor IS calculates the movement speed of the barcode BC on the basis of a difference between the center of gravity positions of the barcode BC in the detection frame 5y and the detection frame 5z.

The calculated movement speed is used for comparison with the movement speed calculated on the basis of the captured images 2a and 2b. As a result, the correctness of the movement speed calculated for the barcode BC can be determined. Note that the movement speed calculated on the basis of the captured images 2a and 2b is the movement speed at the start of the tracking period, and thus is referred to as a “start-time movement speed”. Similarly, the movement speed calculated on the basis of the captured images 2y and 2z is referred to as an “end-time movement speed”.

Note that, in a case where it is not necessary to determine the correctness of the movement speed, cut-out frames 3y and 3z may be set on the basis of the predicted position without specifying the position of the barcode BC by the image processing also in the captured images 2y and 2z.

### 3. Functional Configuration of Signal Processing Device

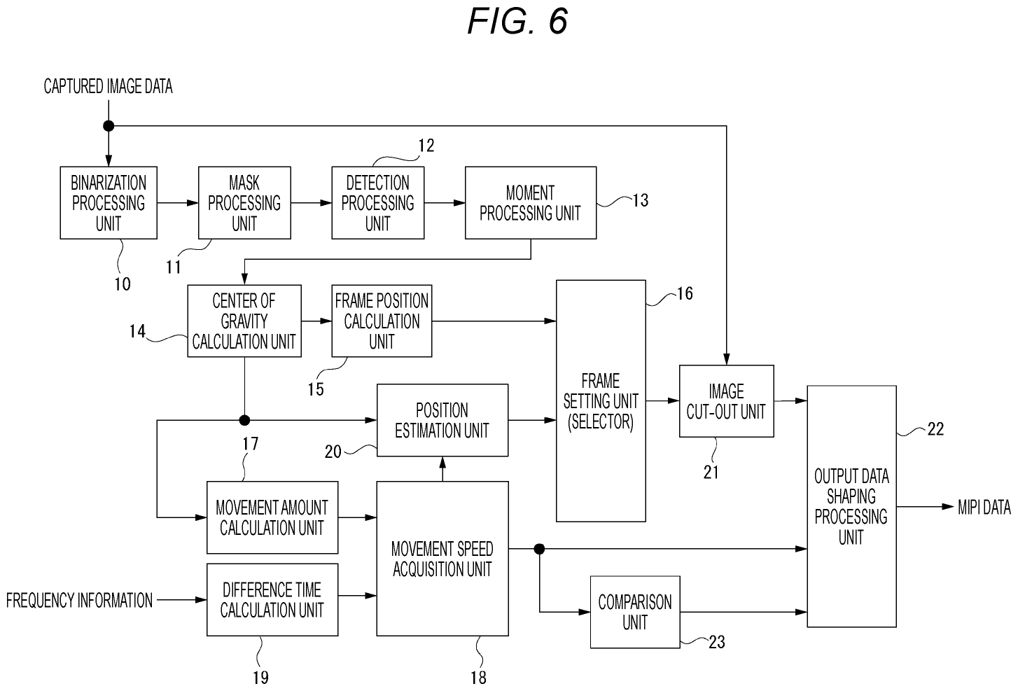

A functional configuration of the image sensor IS as a signal processing device will be described with reference to FIG. 6. Note that each function is realized by hardware processing by the image signal processing unit 42 of the image sensor IS or software processing by the in-sensor control unit 43.

Captured image data supplied from the imaging unit 41 of the image sensor IS is passed to a binarization processing unit 10.

Since the target object to be detected is the barcode BC, the binarization processing unit 10 performs processing of comparing the pixel value of the captured image 2 with the pixel value serving as a threshold value and binarizing the pixel value. Specifically, in a case where the pixel value is less than or equal to the threshold value, the pixel value of the pixel is set to “1”, and in a case where the pixel value is higher than the threshold value, the pixel value of the pixel is set to “0”. As a result, a binarized image in which the pixel value of the black line portion of the barcode BC is “1” is generated.

The binarized image obtained as a result of the binarization processing is supplied to a mask processing unit 11.

The mask processing unit 11 performs mask processing of replacing the pixel value of a region outside the cut-out frame 3 with “0”.

The mask image obtained as a result of the mask processing is supplied to a detection processing unit 12 in a subsequent stage.

The detection processing unit 12 sets the detection frame 5 in a predetermined region in the cut-out frame 3 of the mask processing unit 11, and detects the barcode BC to be detected in the detection frame 5. In a case where it is not detected, the subsequent processing is not performed.

In a case where the barcode BC is detected, the mask image is supplied to a moment processing unit 13.

Note that the detection processing unit 12 is located at the subsequent stage of the mask processing unit 11, but may be configured to detect the barcode BC with respect to the image before binarization. That is, various positions of the detection processing unit 12 can be considered.

The moment processing unit 13 calculates an mnth-order moment M(m, n). The mnth-order moment M(m, n) is calculated by the following Formula (1).

$$[ Mathematical formula 1 ]$$

$$M ( m , n ) = {\sum }_{region A} ( x {coordinate}^{m} \times y {coordinate}^{n} ) \qquad Formula ( 1 )$$

Here, a region A is a region in which the pixel value in the mask image is “1”, and is a black line region of the barcode BC. The moment processing unit 13 calculates M(0, 0), M(1, 0), and M(0, 1).

Each of the calculated values is output to a center of gravity calculation unit 14.

The center of gravity calculation unit 14 calculates the center of gravity position of the barcode BC using M(0, 0), M(1, 0), and M(0, 1). Specifically, the x coordinate of the center of gravity position of the barcode BC is calculated by the following Formula (2), and the y coordinate is calculated by the following Formula (3).

$$[ Mathematical formula 2 ]$$

$$x coordinate of center of gravity position = \frac{M ( 1 , 0 )}{M ( 0 , 0 )} \qquad Formula ( 2 )$$

$$[ Mathematical formula 3 ]$$

$$y coordinate of center of gravity position = \frac{M ( 0 , 1 )}{M ( 0 , 0 )} \qquad Formula ( 3 )$$

Note that the center of gravity calculation unit 14 can be regarded as executing processing of detecting the position of the barcode BC. That is, the center of gravity calculation unit 14 functions as a position detection unit for the barcode BC.

The calculated center of gravity position of the barcode BC is supplied to a frame position calculation unit 15.

The frame position calculation unit 15 calculates the position of the cut-out frame 3 on the basis of the supplied center of gravity position. As a result, the cut-out frame 3 includes the detected barcode BC.

The calculated frame position is supplied to a frame setting unit 16. The processing of the frame setting unit 16 will be described later.

Note that the center of gravity position calculated by the center of gravity calculation unit 14 is also supplied to a movement amount calculation unit 17. Then, the output of the center of gravity positions to the movement amount calculation unit 17 is performed for a plurality of frame images (captured images 2).

The movement amount calculation unit 17 calculates a movement amount of the barcode BC on the basis of the center of gravity position of each of the plurality of captured images 2 supplied from the center of gravity calculation unit 14. Specifically, a difference between the center of gravity positions is calculated.

The calculated movement amount is supplied to a movement speed acquisition unit 18.

Furthermore, to the movement speed acquisition unit 18, a difference between the imaging times of the plurality of frame images for which the center of gravity positions have been calculated is output from a difference time calculation unit 19.

The difference time calculation unit 19 uses frequency (number of clocks) information to calculate the difference time between the frame start timings of each of the plurality of captured images 2 for which the center of gravity positions have been calculated. For example, in a case where the center of gravity position of the captured image 2 as two consecutive frame images is calculated, the reciprocal of the frame rate is calculated as the difference time. The calculated difference time is output to the movement speed acquisition unit 18.

The movement speed acquisition unit 18 calculates a movement speed of the barcode BC on the basis of the movement amount and the difference time of the barcode BC calculated in the captured image 2 as the plurality of frame images.

The calculated movement speed is output to a position estimation unit 20.

The position estimation unit 20 obtains the movement speed of the barcode BC from the movement speed acquisition unit 18 and acquires the current center of gravity position of the barcode BC from the center of gravity calculation unit 14.

The position estimation unit 20 estimates a predicted position of the barcode BC in the captured image 2 for the next frame on the basis of the center of gravity position and the movement speed of the barcode BC. The estimated predicted position is output to the frame setting unit 16.

The frame setting unit 16 sets the cut-out frame 3 so as to include the barcode BC. Note that the frame setting unit 16 functions as a selector. Specifically, the frame setting unit 16 selects one of a frame position (output from the frame position calculation unit 15) obtained by performing image processing on the captured image 2 as the current frame image acquired from the frame position calculation unit 15 and a frame position (output from the position estimation unit 20) according to a predicted position of the barcode BC based on the captured image 2 captured before the current frame image, sets the position of the cut-out frame 3, and outputs the position to an image cut-out unit 21.

For the captured images 2a and 2b illustrated in FIG. 5, the frame setting unit 16 sets the cut-out frame 3 on the basis of the information of the frame position obtained from the frame position calculation unit 15 (first setting processing). That is, for the captured images 2a and 2b, the barcode BC is detected by image processing, and the position of the cut-out frame 3 is set from the center of gravity position.

Then, for the captured images 2c, 2d, and 2e illustrated in FIG. 5, the frame setting unit 16 sets the cut-out frame 3 on the basis of the predicted position of the barcode BC obtained from the position estimation unit 20 (second setting processing). That is, the cut-out frame 3 is set using the predicted position based on the movement speed of the barcode BC calculated on the basis of the difference between the center of gravity positions of the barcode BC obtained from the captured images 2a and 2b.

The frame position of the cut-out frame 3 set by the frame setting unit 16 is output to the image cut-out unit 21.

Note that, in other words, the frame setting unit 16 starts the first setting processing in response to a change from the non-detection state in which the barcode BC is not detected to the detection state in which the barcode BC is detected, and performs a process of switching to the second setting processing in response to the calculation of the movement speed of the barcode BC by the position estimation unit 20.

Not only the frame position of the cut-out frame 3 but also the captured image data are input to the image cut-out unit 21. The image cut-out unit 21 cuts out the ROI image 4 as a partial image on the basis of the cut-out frame 3. The cut-out ROI image 4 is supplied to an output data shaping processing unit 22.

Information on the movement speed of the barcode BC obtained by the movement speed acquisition unit 18 is output to a comparison unit 23.

The comparison unit 23 compares the movement speed of the barcode BC at the time when the calculation of the predicted position of the barcode BC is started with the movement speed of the barcode BC at the time when the calculation of the predicted position is stopped. That is, comparison is made between the start-time movement speed, that is a movement speed at the start point of the tracking period, and the end-time movement speed that is a movement speed at the end point of the tracking period.

Specifically, the movement speed of the barcode BC calculated on the basis of the captured images 2a and 2b illustrated in FIG. 5 is compared with the movement speed of the barcode BC calculated on the basis of the captured images 2y and 2z.

In a case where the discrepancy between the two movement speeds is less than a threshold value, the comparison unit 23 determines that the tracking of the position of the barcode BC has been normally performed. Furthermore, in a case where the discrepancy between the two movement speeds is greater than or equal to the threshold value, it is determined that the tracking of the position of the barcode BC has not been normally performed. A determination result is provided to the output data shaping processing unit 22 as, for example, flag information.

The output data shaping processing unit 22 is supplied with not only the ROI image 4 but also the information of the movement speed of the barcode BC obtained by the movement speed acquisition unit 18 and the comparison result of the movement speed.

The output data shaping processing unit 22 stores each of these pieces of information in each area of a data structure conforming to, for example, the mobile industry processor interface (MIPI) standard, and transmits the information to a processing unit in the subsequent stage. The processing unit in the subsequent stage is, for example, the control unit 33 illustrated in FIG. 1, a control unit included in a device provided outside the camera apparatus 1, or the like.

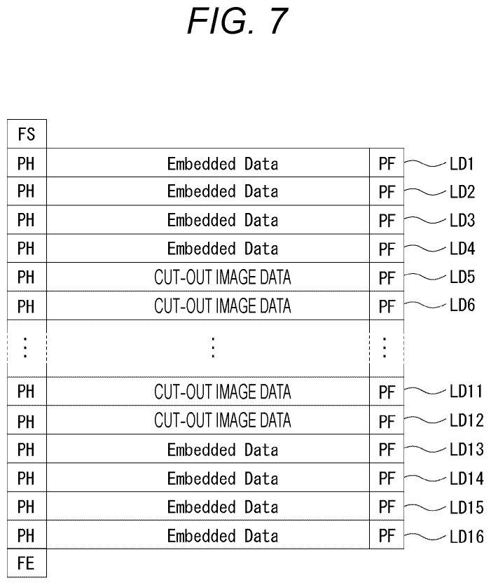

Here, an example of a data structure conforming to the MIPI standard will be described with reference to FIG. 7.

Packet data (hereinafter referred to as “MIPI data”) conforming to the MIPI standard and output in one frame period is transmitted as a series of packet data (line data) which starts with a frame start (“FS” in the drawing) and ends with a frame end (“FE” in the drawing).

The MIPI data is transmitted as frame data in which a plurality of packets is connected between the frame start and the frame end. Each packet data includes a packet header (“PH” in the drawing), a payload area, and a packet footer (“PF” in the drawing), and various types of transmission data are stored in the payload area.

In the example illustrated in FIG. 6, first, after the frame start, a packet (line data LD1, LD2, LD3, and LD4) in which embedded data (“Embedded Data” in the drawing) is stored in the payload area is transmitted, next, a packet (line data LD5, LD6, . . . . LD11, L12) in which data of the ROI image 4 by the cut-out frame 3 is stored in the payload area is transmitted, and further, a packet (line data LD13, LD14, LD15, and LD16) in which embedded data is stored in the payload area is transmitted.

The output data shaping processing unit 22 illustrated in

FIG. 6 stores the ROI image 4 cut out by the image cut-out unit 21 in the payload areas of the line data LD5, LD6, . . . , LD11, and LD12 as cut-out image data.

Furthermore, the output data shaping processing unit 22 stores the information of the movement speed supplied from the movement speed acquisition unit 18 and the information of the comparison result supplied from the comparison unit 23 as embedded data in the payload areas of the line data LD1, LD2, LD3, and LD4.

Note that the movement speed information and the comparison result information may be stored in the payload areas of the line data LD13, LD14, LD15, and LD16. However, by transmitting the information of the movement speed and the information of the comparison result before the ROI image 4 is transmitted, it is easy to end the setting change of the object transport device, the imaging setting change of the camera apparatus 1, and the like before the ROI image 4 for the next frame is output. Therefore, it is possible to quickly perform processing for coping with a case where the barcode BC cannot be followed.

Note that, in a case where the barcode BC cannot be normally followed, a process of returning from the second setting processing to the first setting processing described above may be performed in addition to the speed change of the object transport device. That is, the state may be returned to the state in which the barcode BC is specified by the image processing without using the predicted position.

Note that the information on the movement speed and the information on the comparison result are output as metadata of the cut-out image data. Furthermore, the information of the center of gravity position of the barcode BC may also be output as the metadata.

### 4. Flow of Processing

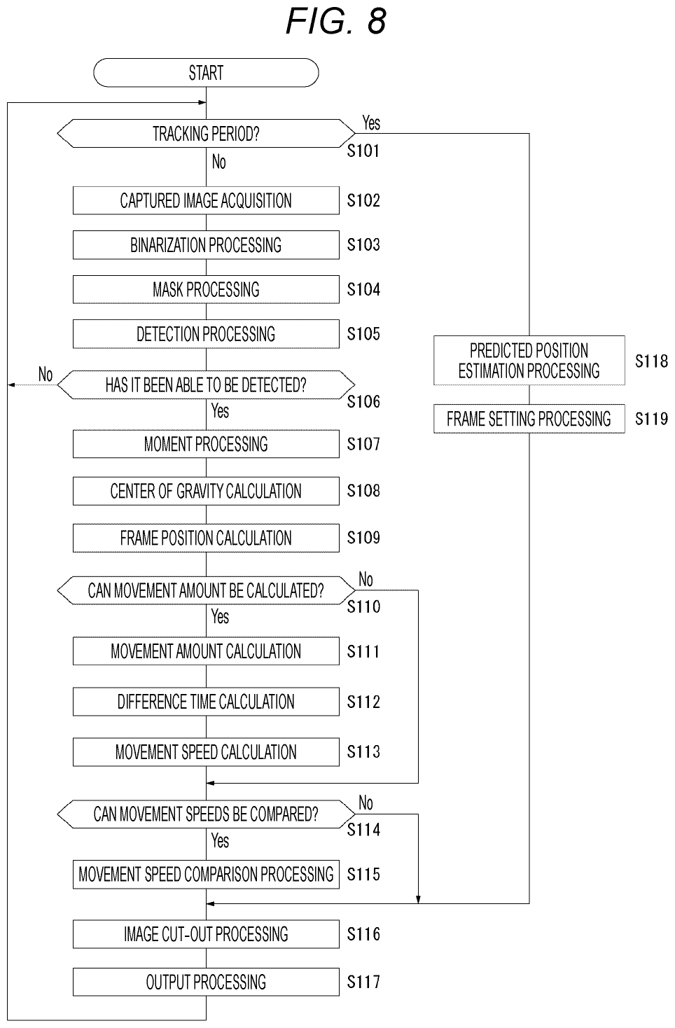

A flow of processing executed by the control unit (the image signal processing unit 42 or the in-sensor control unit 43) of the image sensor IS will be described with reference to FIG. 8. Note that the order of respective processing illustrated in FIG. 8 is an example, and the order of some processing may be executed one behind the other.

In step S101, the control unit of the image sensor IS determines whether or not it is a tracking period. The tracking period is a period in which the cut-out frame 3 is set on the basis of the predicted position of the barcode BC as described above.

For example, in a state where the barcode BC is not detected, it is determined that it is not the tracking period. In this case, the control unit of the image sensor IS acquires the captured image 2 from the imaging unit 41 in step S102.

Subsequently, the control unit of the image sensor IS performs binarization processing in step S103, and then performs mask processing in step S104. Note that, since each processing has been described above, detailed description thereof will be omitted. Details may be omitted in each processing described below.

Subsequently, in step S105, the control unit of the image sensor IS performs detection processing of the barcode BC. A target region of the detection processing is a region in the detection frame 5 set on the captured image 2.

In a case where the barcode BC cannot be detected, for example, in a case of the captured image 2A illustrated in FIG. 4, the control unit of the image sensor IS returns to the processing of step S101 again.

On the other hand, in a case where it is determined that the detection has been successfully performed, for example, in a case of the captured image 2C illustrated in FIG. 4, the control unit of the image sensor IS performs moment processing in step S107.

The control unit of the image sensor IS calculates the center of gravity position of the barcode BC in subsequent step S108, and calculates the position of the cut-out frame 3 in step S109.

The control unit of the image sensor IS calculates the position of the cut-out frame 3 based on the image processing by performing a series of the processing shown in steps S102 to S109. As a result, the cut-out frame 3 is set based on the image processing. This is the first setting processing described above.

In step S110, the control unit of the image sensor IS determines whether or not the movement amount can be calculated. For example, in a case where the center of gravity position of the barcode BC is detected in both the captured image 2a and the captured image 2b illustrated in FIG. 5, it is determined that the movement amount can be calculated.

In this case, the control unit of the image sensor IS calculates the movement amount in step S111, calculates the difference time in step S112, and calculates the movement speed in step S113.

That is, the control unit of the image sensor IS calculates the movement speed of the barcode BC necessary for estimating the predicted position of the barcode BC by executing a series of the processing illustrated in steps S111 to S113.

Furthermore, at the time point when the captured image 2a illustrated in FIG. 5 is acquired, since there is only one piece of information on the center of gravity position of the barcode BC, it is determined in step S110 that the movement amount cannot be calculated.

In this case, the control unit of the image sensor IS proceeds to step S114 without executing each processing of steps S111, S112, and S113.

In step S114, the control unit of the image sensor IS determines whether or not the movement speeds can be compared.

For example, at the timing after the processing of step S113 is executed on the captured image 2z illustrated in FIG. 5, both the start-time movement speed based on the captured images 2a and 2b and the end-time movement speed based on the captured images 2y and 2z are obtained. Therefore, both the movement speeds can be compared.

In this case, the control unit of the image sensor IS performs the movement speed comparison processing in step S115, and supplies a comparison result to the output data shaping processing unit 22.

On the other hand, at the time of acquiring the captured image 2b illustrated in FIG. 5 or the like, since only one movement speed is obtained, it is determined in step S114 that the movement speeds cannot be compared.

In this case, the processing in step S115 is avoided.

The control unit of the image sensor IS performs processing of cutting out the ROI image 4 on the basis of the set cut-out frame 3 in step S116, and performs processing of outputting the ROI image 4 and the metadata in step S117.

Note that, in the output processing of step S117, in a case where the movement speed is calculated, the movement speed is output as metadata. Furthermore, in a case where the comparison result of the movement speed is calculated, the comparison result is output as metadata.

After the processing of step S117, the control unit of the image sensor IS returns to the processing of step S101.

In a case where it is determined in the determination processing of step S101 that it is the tracking period, the control unit of the image sensor IS proceeds to processing of step S118.

For example, it is determined that it is the tracking period at the timings when the captured images 2c, 2d, and 2e illustrated in FIG. 5 are acquired. In this case, each processing of steps S102 to S109, that is, the image processing for specifying the position of the barcode BC is not performed.

In step S118, the control unit of the image sensor IS performs predicted position estimation processing. Furthermore, in step S119, the control unit of the image sensor IS performs processing of setting the cut-out frame 3 on the basis of the predicted position. This is the second setting processing described above.

Thereafter, the control unit of the image sensor IS executes each processing of steps S116 and S117 to perform image cut-out processing and processing of outputting data.

### 5. Second Embodiment

An image sensor IS as a signal processing device in a second embodiment has a configuration capable of externally providing information on the movement speed of a barcode BC.

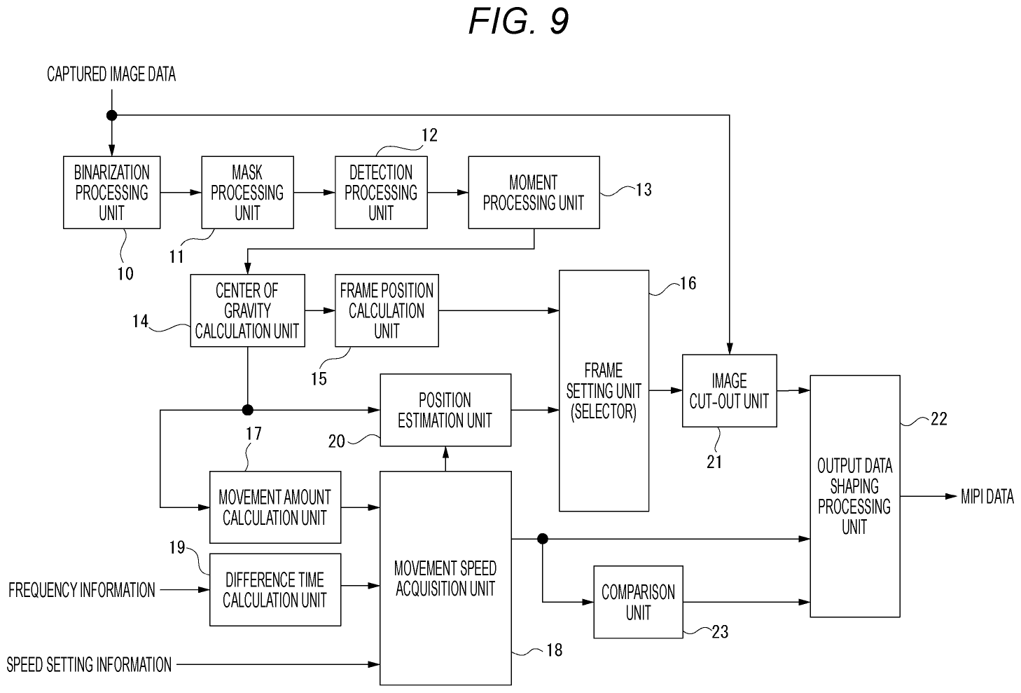

This will be specifically described with reference to FIG. 9.

FIG. 9 is a diagram corresponding to FIG. 6 in the first embodiment, and illustrates a functional configuration of the image sensor IS.

Note that description of parts similar to the parts described with reference to FIG. 6 will be omitted as appropriate.

A movement speed acquisition unit 18 can calculate the movement speed of the barcode BC on the basis of the movement amount of the barcode BC calculated by a movement amount calculation unit 17 and the difference time calculated by a difference time calculation unit 19.

Furthermore, the movement speed acquisition unit 18 in the present embodiment is configured to be able to acquire and adopt a movement speed input from the outside of the image sensor IS or the outside of a camera apparatus 1 instead of calculating the movement speed.

The input of the movement speed from the outside is, for example, a movement speed input in a case where the movement speed of an object flowing on the line is known by setting of the object transport device or the like, and is information on the speed setting.

In a case where the information regarding the movement speed is input from the outside, by further specifying the position of the barcode BC for one captured image 2, the movement of the barcode BC thereafter can be specified, and the predicted position of the barcode BC can be estimated.

Therefore, with respect to the captured image 2 as the subsequent frame image, each processing in a binarization processing unit 10, a mask processing unit 11, a detection processing unit 12, a moment processing unit 13, a center of gravity calculation unit 14, a frame position calculation unit 15, the movement amount calculation unit 17, the difference time calculation unit 19, and a comparison unit 23 can be omitted, and the processing load can be reduced.

### 6. Third Embodiment

An image sensor IS as a signal processing device in a third embodiment calculates the movement speed of a barcode BC outside the image sensor IS or outside a camera apparatus 1.

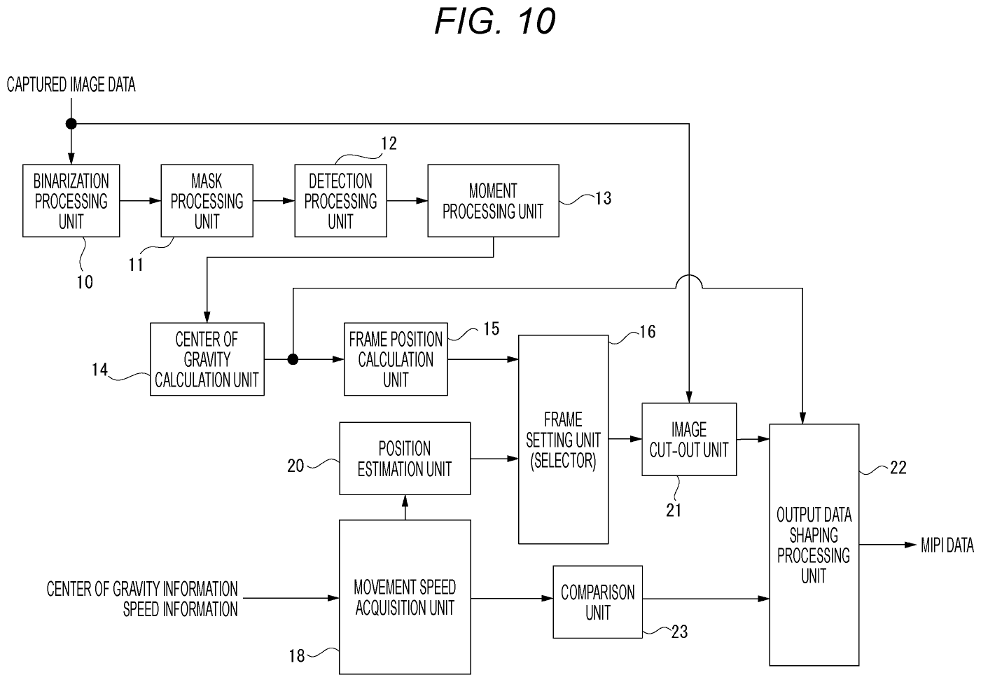

This will be specifically described with reference to FIG. 10.

FIG. 10 is a diagram corresponding to FIG. 6 in the first embodiment and FIG. 9 in the second embodiment, and illustrates a functional configuration of the image sensor IS.

Note that description of parts similar to the parts described with reference to FIG. 6 will be omitted as appropriate.

A center of gravity calculation unit 14 provides the calculated center of gravity position to an output data shaping processing unit 22. As a result, the center of gravity position of the barcode BC is output to a control unit 33 outside the image sensor IS or a device outside the camera apparatus 1. Here, these devices are referred to as “external devices”.

The external device calculates the movement speed of the barcode BC on the basis of the received plurality of center of gravity positions. Then, the external device provides the calculated movement speed and the received information of the center of gravity position to a movement speed acquisition unit 18 of the image sensor IS.

The movement speed acquisition unit 18 receives information on the center of gravity position and information on the movement speed from the external device and provides the information to a position estimation unit 20.

The position estimation unit 20 estimates a predicted position of the barcode BC on the basis of the information of the center of gravity position and the information of the movement speed, and provides the predicted position to a frame setting unit 16.

In this manner, the image sensor IS sets a cut-out frame 3 using the information of the movement speed of the barcode BC calculated in the external device.

Furthermore, in a case where the movement speed acquisition unit 18 obtains a plurality of the movement speeds, by outputting information of the plurality of movement speeds to a comparison unit 23, the comparison unit 23 performs processing of comparing the two movement speeds, and it is determined whether or not tracking of the position of the barcode BC has been normally performed. A determination result is provided to the output data shaping processing unit 22 as, for example, flag information.

By calculating the movement speed of the barcode BC outside the image sensor IS, an amount of calculation in the image sensor IS is reduced, and the processing load is reduced.

Note that the function of the comparison unit 23 may be provided by an external device of the image sensor IS or an external device of the camera apparatus 1.

### 7. Summary

As described in each of the examples described above, the image sensor IS as a signal processing device includes: a position detection unit (center of gravity calculation unit 14) that detects, on the basis of the captured image 2 by the imaging unit 41 that captures a moving target object (for example, a barcode BC), detects a position of the target object in the captured image 2 as an object position; a position estimation unit 20 that estimates a position of the target object in the captured image 2 of next and subsequent frames as a predicted position on the basis of the detected object position and a movement speed of the target object; and a frame setting unit 16 that sets the cut-out frame 3 in the captured image 2 of the next and subsequent frames according to the predicted position.

As a result, the cut-out frame 3 can be set to include the position of the target object predicted on the basis of the object position and the movement speed.

Therefore, by performing the image processing on the captured image 2 of each frame, the frequency of the image processing is reduced as compared with the case where the object position is detected each time, and thus the processing load can be reduced.

Note that the target object is moved in one direction at a constant speed, for example. The term “constant speed” as used herein includes, for example, a case where even in a case where the movement speed of the target object finely changes due to vibration or the like during the operation of the drive mechanism of the belt conveyor, the target object can be regarded as moving at a substantially constant speed as a whole.

Furthermore, the rectangular frame has been exemplified in the example described above for the cut-out frame 3, but the cut-out frame 3 may have any shape such as a circular shape, an elliptical shape, or a star shape.

As described with reference to FIG. 6 and the like, the image sensor IS as the signal processing device may include the movement speed acquisition unit 18 that acquires the movement speed of the target object (for example, the barcode BC).

By acquiring the movement speed of the target object, the predicted position can be estimated with high accuracy in accordance with the object position of the target object.

As described with reference to FIG. 6 and the like, the movement speed acquisition unit 18 of the image sensor IS as the signal processing device may calculate the movement speed on the basis of a difference between the object positions in the captured images 2 of a plurality of frames.

Specifically, the movement speed acquisition unit 18 can calculate the movement speed of the target object (for example, the barcode BC) on the basis of a length of the frame period and the difference (distance) of the object positions. That is, the movement speed of the target object can be calculated by the image processing.

For example, in a case where the movement speed of the target object cannot be obtained, the movement speed can be specified from the captured image 2.

As described with reference to FIG. 9 and the like, the movement speed acquisition unit 18 of the image sensor IS as the signal processing device may acquire information input about the movement speed.

For example, the movement speed acquisition unit 18 may acquire the movement speed input by the user, or may acquire the movement speed of the belt conveyor input by processing executed in another device. That is, the predicted position of the target object (for example, the barcode BC) may be calculated on the basis of the movement speed input from the outside.

For example, in a case where the movement speed of the target object cannot be obtained by the image processing on the captured image 2, information on the movement speed can be obtained.

As described with reference to FIG. 6 and the like, the image sensor IS as the signal processing device may include the center of gravity calculation unit 14 that calculates the center of gravity position of the target object (for example, the barcode BC) on the captured image 2, and the position detection unit (center of gravity calculation unit 14) may detect the object position on the basis of the center of gravity position.

That is, the object position is calculated by calculating the center of gravity position of the target object in each of the two captured images 2. Then, the movement amount of the target object is specified by the difference between the object positions. As a result, the movement speed of the target object can be calculated by the image processing.

Therefore, even in a case where a specific position in the target object cannot be detected, the movement speed of the target object can be calculated in a case where the center of gravity position can be calculated.

As described with reference to FIG. 6 and the like, the image sensor IS as the signal processing device may include the output unit (output data shaping processing unit 22) that outputs the center of gravity position.

By outputting the center of gravity position, it is possible to calculate the movement speed of the target object (for example, the barcode BC) in a device outside the signal processing device. That is, it is possible to reduce the processing load on the signal processing device.

As described with reference to FIG. 10 and the like, the image sensor IS as the signal processing device may include the movement speed acquisition unit 18 that acquires the movement speed calculated outside on the basis of the center of gravity position output from the output unit (output data shaping processing unit 22).

The predicted position can be estimated using the movement speed for the target object (for example, the barcode BC) calculated externally. Therefore, the processing load of the signal processing device can be reduced.

As described with reference to FIG. 2 and the like, the position detection unit (center of gravity calculation unit 14) of the image sensor IS as the signal processing device may detect the object position in the detection frame 5 set as a partial region of the captured image 2.

As a result, a region as a detection target of the target object (for example, the barcode BC) can be limited to a region in the detection frame 5, and the processing load for the processing of detecting the target object can be reduced.

As described with reference to FIG. 2 and the like, the frame setting unit 16 of the image sensor IS as the signal processing device may set the cut-out frame 3 such that the target object (for example, the barcode BC) detected in the detection frame 5 is included.

As a result, it is possible to output the cut-out image including the target object to another device with a small processing load. Furthermore, it is possible to reduce the burden of image processing in a device at a subsequent stage rather than outputting the entire captured image 2.

As described with reference to FIG. 7 and the like, the image sensor IS as the signal processing device may include the output unit (output data shaping processing unit 22) that outputs the movement speed acquired by the movement speed acquisition unit 18.

As a result, the movement speed and the like calculated in the signal processing device can be presented to the user in another device. Therefore, it is possible for the user to determine whether or not the movement speed is normal, and convenience is improved.

As described with reference to FIG. 6 and the like, the frame setting unit 16 of the image sensor IS as the signal processing device may be switchable between the first setting processing of setting the cut-out frame 3 on the basis of the object position detected in the captured image 2 and the second setting processing of setting the cut-out frame 3 on the basis of the predicted position.

As a result, it is possible to selectively use setting of the cut-out frame 3 including the target object (for example, the barcode BC) in the first setting processing based on the image processing and setting of the cut-out frame 3 in the second setting processing based on the predicted position where the image processing is not performed. Therefore, it is possible to, according to the situation, selectively use the cut-out frame 3 including the object position specified with high accuracy and the cut-out frame 3 including the specified predicted position while reducing the processing load.

Note that, in a situation where the target object moves at a substantially constant speed in one direction, the prediction position can be calculated with high accuracy, and thus, it is possible to achieve both reduction of the processing load and tracking of the target object with high accuracy.

As described with reference to FIG. 8 and the like, the position detection unit (center of gravity calculation unit 14) of the image sensor IS as the signal processing device may not perform the processing of detecting the object position in the captured image 2 in the second setting processing.

As a result, the processing load during the execution of the second setting processing is reduced.

As described with reference to FIG. 8 and the like, the frame setting unit 16 of the image sensor IS as the signal processing device may start the first setting processing in response to the change from the non-detection state in which the target object (for example, the barcode BC) is not detected to the detection state in which the target object is detected, and switch from the first setting processing to the second setting processing in response to the calculation of the movement speed, and may include the movement speed acquisition unit 18 that calculates and acquires the start-time movement speed that is the movement speed at the start of the tracking period in which the second setting processing is performed and the end-time movement speed that is the movement speed at the end of the tracking period, and the output unit (output data shaping processing unit 22) that outputs the comparison result between the start-time movement speed and the end-time movement speed.

The correctness of the calculated movement speed can be determined by comparing the start-time movement speed and the end-time movement speed. Therefore, by presenting the comparison result in another information processing device or the like from which the comparison result is output, the user can grasp the correctness of the calculated movement speed.

Note that the movement amount per frame period may be calculated instead of the movement speed.

As described with reference to FIG. 7 and the like, the image sensor IS as the signal processing device may include the output unit (the output data shaping processing unit 22) that outputs the cut-out image data (the data of the ROI image 4) cut out by the cut-out frame 3 and the metadata of the cut-out image data, and the metadata may include at least one of the movement speed and the center of gravity position of the target object (for example, the barcode BC) on the captured image 2 and be stored in the embedded data area in the data structure conforming to the mobile industry processor interface (MIPI) standard.

As a result, both the cut-out image data and the metadata can be transmitted in a data format conforming to the MIPI standard.

As described with reference to FIG. 7 and the like, in the image sensor IS as the signal processing device, the metadata may be stored in the payload area of the line data transmitted before the line data in which the cut-out image data (the data of the ROI image 4) is stored among the plurality of line data included in the same frame data in the data structure conforming to the MIPI standard.

As a result, it is possible to lengthen the time from the reception of the metadata to the reception of the next frame data in the information processing device that has received the data of the MIPI standard. Therefore, the setting of the belt conveyor and the change of the imaging setting based on the metadata can be completed before the next frame data is received. That is, it is possible to quickly change the setting based on the metadata.

As described with reference to FIG. 2 and the like, in the image sensor IS as the signal processing device, the target object may be a barcode (a one-dimensional code, a two-dimensional code, or the like) provided on an object.

For example, the cut-out frame 3 is set for each frame according to the movement speed of the belt conveyor so that the one-dimensional code or the two-dimensional code attached to a surface of a packaging material of the product enters the frame. Therefore, it is possible to easily inspect forgetting to attach the barcode to the packaging material.

As described with reference to FIG. 6 and the like, the image sensor IS as a signal processing device may include the binarization processing unit 10 that generates a binarized image obtained by binarizing the captured image 2, and the position detection unit (center of gravity calculation unit 14) may detect the object position with respect to the binarized image.

For the barcode formed in black and white, image processing is simplified by binarizing the captured image 2, and a processing load can be reduced.

As described with reference to FIG. 1 and the like, the signal processing device may include the image sensor IS including the imaging unit 41.

The setting of the cut-out frame 3 following the target object (for example, the barcode BC), the cut-out of the image by the cut-out frame 3, and the like are performed in the image sensor, so that the amount of calculation for the processing performed outside the image sensor can be reduced.

A signal processing method according to the present technology causes a computer device to execute processing of, on the basis of a captured image by an imaging unit that captures a moving target object, detecting a position of the target object in the captured image as an object position, estimating a position of the target object in the captured image of next and subsequent frames as a predicted position on the basis of the detected object position and a movement speed of the target object, and setting a cut-out frame in the captured image of the next and subsequent frames according to the predicted position.

A program according to the present technology is a program for causing, for example, the image signal processing unit 42 and the in-sensor control unit 43 included in the image sensor IS to execute a function of, on the basis of a captured image by an imaging unit that captures a moving target object, detecting a position of the target object in the captured image as an object position, a function of estimating a position of the target object in the captured image of next and subsequent frames as a predicted position on the basis of the detected object position and a movement speed of the target object, and a function of setting a cut-out frame in the captured image of the next frame and subsequent frames according to the predicted position.

With such a program, in the image sensor IS as the signal processing device described above, it is possible to reduce the processing load on the ROI function for tracking the subject.

Such programs can be recorded in advance in a hard disk drive (HDD) as a recording medium built in a device such as a computer device, a ROM in a microcomputer having a CPU, or the like. Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program may be installed from the removable recording medium into a personal computer and the like, or may be downloaded from a download site through a network such as a local area network (LAN) or the Internet.

Note that, the effects described in the present specification are merely examples and are not limited, and other effects may be provided.

Furthermore, the above-described examples may be combined in any way, and the above-described various functions and effects may be obtained even in a case where various combinations are used.

### 8. Present Technology Note that the present technology can also adopt the following configurations.

(1)

A signal processing device including:

a position detection unit that, on the basis of a captured image by an imaging unit that captures a moving target object, detects a position of the target object in the captured image as an object position;

a position estimation unit that estimates a position of the target object in the captured image of next and subsequent frames as a predicted position on the basis of the detected object position and a movement speed of the target object; and

a frame setting unit that sets a cut-out frame in the captured image of the next and subsequent frames according to the predicted position.

(2)

The signal processing device according to (1) described above, further including

a movement speed acquisition unit that acquires the movement speed of the target object.

(3)

The signal processing device according to (2) described above,

in which the movement speed acquisition unit calculates the movement speed on the basis of a difference between the object positions in the captured images of a plurality of frames.

(4)

The signal processing device according to any one of (2) described above to (3) described above,

in which the movement speed acquisition unit acquires information input about the movement speed.

(5)

The signal processing device according to any one of (1) described above to (4) described above, further including

a center of gravity calculation unit that calculates a center of gravity position of the target object on the captured image,

in which the position detection unit detects the object position on the basis of the center of gravity position.

(6)

The signal processing device according to (5) described above, further including

an output unit that outputs the center of gravity position.

(7)

The signal processing device according to (6) described above, further including

a movement speed acquisition unit that acquires the movement speed calculated outside on the basis of the center of gravity position output from the output unit.

(8)

The signal processing device according to any one of (1) described above to (7) described above,

in which the position detection unit detects the object position in a detection frame set as a partial region of the captured image.

(9)

The signal processing device according to (8) described above,

in which the frame setting unit sets the cut-out frame such that the target object detected in the detection frame is included.

(10)

The signal processing device according to any one of (2) described above to (4) described above, further including

an output unit that outputs the movement speed acquired by the movement speed acquisition unit.

(11)

The signal processing device according to any one of (1) described above to (10) described above described above,

in which the frame setting unit is switchable between first setting processing of setting the cut-out frame on the basis of the object position detected in the captured image and second setting processing of setting the cut-out frame on the basis of the predicted position.

(12)

The signal processing device according to (11) described above,

in which the position detection unit does not perform processing of detecting the object position in the captured image in the second setting processing.

(13)

The signal processing device according to any one of (11) described above to (12) described above,

in which the frame setting unit starts the first setting processing in response to a change from a non-detection state in which the target object is not detected to a detection state in which the target object is detected, and switches from the first setting processing to the second setting processing in response to calculation of the movement speed, and

the signal processing device includes:

a movement speed acquisition unit that calculates and acquires a start-time movement speed that is the movement speed at a start of a tracking period in which the second setting processing is performed and an end-time movement speed that is the movement speed at an end of the tracking period; and

an output unit that outputs a comparison result between the start-time movement speed and the end-time movement speed.

(14)

The signal processing device according to any one of (1) described above to (13) described above, further including

an output unit that outputs cut-out image data cut out by the cut-out frame and metadata of the cut-out image data,

in which the metadata

includes at least one of the movement speed and a center of gravity position of the target object on the captured image, and

is stored in an embedded data area in a data structure conforming to a mobile industry processor interface (MIPI) standard.

(15)

The signal processing device according to (14) described above,

in which the metadata is stored in a payload area of line data transmitted before line data in which the cut-out image data is stored among a plurality of line data included in same frame data in a data structure conforming to the MIPI standard.

(16)

The signal processing device according to any one of (1) described above to (15) described above,

in which the target object is a barcode provided on an object.

(17)

The signal processing device according to (16) described above, further including

a binarization processing unit that generates a binarized image obtained by binarizing the captured image,

in which the position detection unit detects the object position with respect to the binarized image.

(18)

The signal processing device according to any one of (1) described above to (17) described above, further including

an image sensor including the imaging unit.

(19)

A signal processing method for causing a computer device to execute processing of:

on the basis of a captured image by an imaging unit that captures a moving target object, detecting a position of the target object in the captured image as an object position;

estimating a position of the target object in the captured image of next and subsequent frames as a predicted position on the basis of the detected object position and a movement speed of the target object; and

setting a cut-out frame in the captured image of the next and subsequent frames according to the predicted position.

### Reference Signs List

2, 2A, 2B, 2C, 2D, 2E Captured image
2a, 2b, 2c, 2d, 2e, 2y, 2z Captured image
3, 3A, 3B, 3C, 3D, 3E Cut-out frame
3a, 3b, 3c, 3d, 3e, 3y, 3z Cut-out frame
4, 4A, 4B, 4C, 4D, 4E ROI image (cut-out image)
4a, 4b, 4c, 4d, 4e, 4y, 4z ROI image (cut-out image)
5, 5A, 5B, 5C, 5D, 5E Detection frame
5a, 5b, 5y, 5z Detection frame
10 Binarization processing unit
14 Center of gravity calculation unit (position detection unit)
16 Frame setting unit
18 Movement speed acquisition unit
20 Position estimation unit
22 Output data shaping processing unit (output unit)
41 Imaging unit
IS Image sensor
BC Barcode (target object)

1. A signal processing device comprising:
a position detection unit that, on a basis of a captured image by an imaging unit that captures a moving target object, detects a position of the target object in the captured image as an object position;
a position estimation unit that estimates a position of the target object in the captured image of next and subsequent frames as a predicted position on a basis of the detected object position and a movement speed of the target object; and
a frame setting unit that sets a cut-out frame in the captured image of the next and subsequent frames according to the predicted position.

2. The signal processing device according to claim 1, further comprising
a movement speed acquisition unit that acquires the movement speed of the target object.

3. The signal processing device according to claim 2,
wherein the movement speed acquisition unit calculates the movement speed on a basis of a difference between the object positions in the captured images of a plurality of frames.

4. The signal processing device according to claim 2,
wherein the movement speed acquisition unit acquires information input about the movement speed.

5. The signal processing device according to claim 1, further comprising
a center of gravity calculation unit that calculates a center of gravity position of the target object on the captured image,
wherein the position detection unit detects the object position on a basis of the center of gravity position.

6. The signal processing device according to claim 5, further comprising
an output unit that outputs the center of gravity position.

7. The signal processing device according to claim 6, further comprising
a movement speed acquisition unit that acquires the movement speed calculated outside on a basis of the center of gravity position output from the output unit.

8. The signal processing device according to claim 1,
wherein the position detection unit detects the object position in a detection frame set as a partial region of the captured image.

9. The signal processing device according to claim 8,
wherein the frame setting unit sets the cut-out frame such that the target object detected in the detection frame is included.

10. The signal processing device according to claim 2, further comprising
an output unit that outputs the movement speed acquired by the movement speed acquisition unit.

11. The signal processing device according to claim 1,
wherein the frame setting unit is switchable between first setting processing of setting the cut-out frame on a basis of the object position detected in the captured image and second setting processing of setting the cut-out frame on a basis of the predicted position.

12. The signal processing device according to claim 11,
wherein the position detection unit does not perform processing of detecting the object position in the captured image in the second setting processing.

13. The signal processing device according to claim 11,
wherein the frame setting unit starts the first setting processing in response to a change from a non-detection state in which the target object is not detected to a detection state in which the target object is detected, and switches from the first setting processing to the second setting processing in response to calculation of the movement speed, and
the signal processing device includes:
a movement speed acquisition unit that calculates and acquires a start-time movement speed that is the movement speed at a start of a tracking period in which the second setting processing is performed and an end-time movement speed that is the movement speed at an end of the tracking period; and
an output unit that outputs a comparison result between the

14. The signal processing device according to claim 1, further comprising:
an output unit that outputs cut-out image data cut out by the cut-out frame and metadata of the cut-out image data,
wherein the metadata
includes at least one of the movement speed and a center of gravity position of the target object on the captured image, and
is stored in an embedded data area in a data structure conforming to a mobile industry processor interface (MIPI) standard.

15. The signal processing device according to claim 14,
wherein the metadata is stored in a payload area of line data transmitted before line data in which the cut-out image data is stored among a plurality of line data included in same frame data in a data structure conforming to the MIPI standard.

16. The signal processing device according to claim 1,
wherein the target object is a barcode provided on an object.

17. The signal processing device according to claim 16, further comprising
a binarization processing unit that generates a binarized image obtained by binarizing the captured image,
wherein the position detection unit detects the object position with respect to the binarized image.

18. The signal processing device according to claim 1, comprising
an image sensor including the imaging unit.

19. A signal processing method for causing a computer device to execute processing of:
on a basis of a captured image by an imaging unit that captures a moving target object, detecting a position of the target object in the captured image as an object position;
estimating a position of the target object in the captured image of next and subsequent frames as a predicted position on a basis of the detected object position and a movement speed of the target object; and
setting a cut-out frame in the captured image of the next and subsequent frames according to the predicted position.
